(19) United States
(12) Patent Application Publication
(10) Pub. No.: US 2010/0046933 A1
(43) Pub. Date: Feb. 25, 2010

(54) MOTOR DRIVING SYSTEM

(75) Inventor: Chia-Hung SUN, Tucheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/241,097

(22) Filed: Sep. 30, 2008

(30) Foreign Application Priority Data
Aug. 20, 2008 (CN) 200810304080.4

(51) Int. Cl. H02P 7/28

(52) U.S. Cl. 388/825

(57) ABSTRACT

A motor driving system includes a power supply, a driver, a motor, and a control unit. The driver includes a driving module and a power converting module. The driving module is connected to the power supply. The power converting module is connected to the power supply. The motor includes a power terminal connected to the power converting module. The control unit is connected to the power converting module. The power supply is configured to provide power for the driver. The driving module is configured to control the motor. The control unit is configured to control the power converting module to output a changeable voltage to the motor.

### BACKGROUND

1. Field of the Invention

The present disclosure relates to a motor driving system.

2. Description of the Related Art

A motor driving system includes a motor, a driver, and a power supply. The power supply is electronically coupled to the motor and the driver. The driver is also connected to the motor to output a control signal to the motor to control speed of the motor. Because the motor and the driver receive the same voltage, speed control range of the motor driving system is too narrow.

Therefore, what is needed, is a motor driving system which can solve the above problem.

### BRIEF DESCRIPTION OF THE DRAWINGS

FIG. 1 is a block diagram of a first exemplary embodiment of a motor driving system, the motor driving system including a step up circuit and a step down circuit.

FIG. 2 is a circuit diagram of one embodiment of the step up circuit of FIG. 1.

FIG. 3 is a circuit diagram of one embodiment of the step down circuit of FIG. 1.

FIG. 4 is a block diagram of a second exemplary embodiment of a motor driving system.

### DETAILED DESCRIPTION

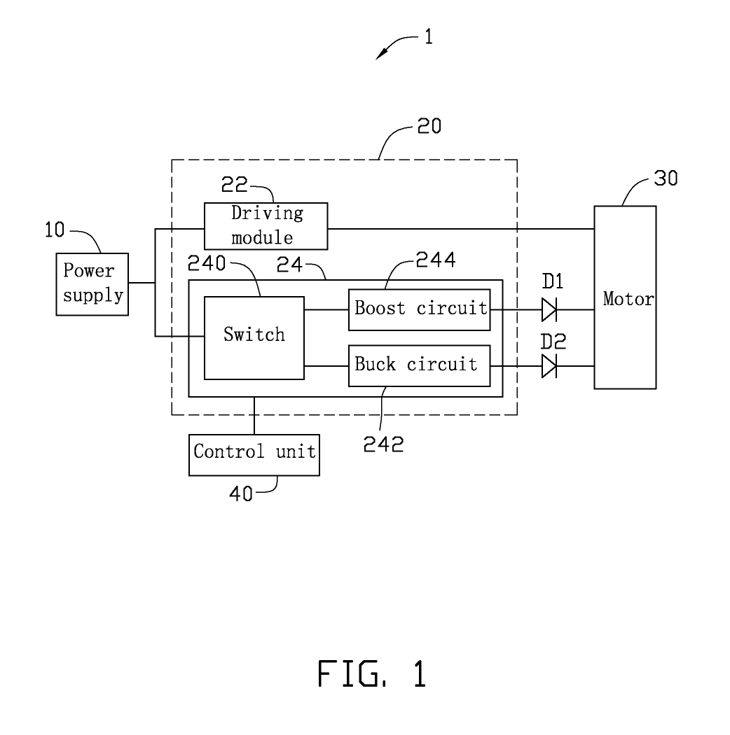

Referring to FIG. 1, a first exemplary motor driving system 1 includes a power supply 10, a driver 20, a motor 30, and a control unit 40. The driver 20 includes a driving module 22 and a power converting module 24. The power converting module 24 includes a switch 240, a step down circuit such as a buck circuit 242, and a step up circuit such as a boost circuit 244.

The power supply 10 is connected to the driving module 22 and the switch 240. The driving module 22 is also connected to a control terminal of the motor 30 to output a control signal to the motor 30. The switch 240 is also connected to the control unit 40 to selectively connect the power supply 10 to an input terminal of the buck circuit 242 or the boost circuit 244 according to the control unit 40. The control unit 40 is also connected to the buck circuit 242 and the boost circuit 244. An output terminal of the boost circuit 244 is connected to an anode of a first diode D1. A cathode of the first diode D1 is connected to a power terminal of the motor 30. An output terminal of the buck circuit 242 is connected to an anode of a second diode D2. A cathode of the second diode D2 is connected to the power terminal of the motor 30. The first and second diodes D1, D2 are configured to prevent electric current flowing from the motor 30 to the boost circuit 244 and the buck circuit 242 respectively.

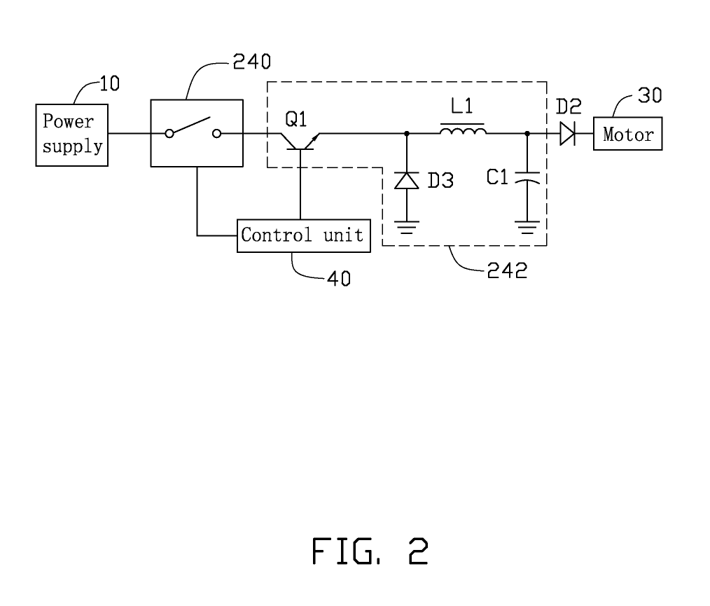

Referring to FIG. 2, the buck circuit 242 includes a first switch such as a first transistor Q1, a first inductor L1, a third diode D3, and a first capacitor C1. A collector of the first transistor Q1 serving as the input terminal of the buck circuit 242 is selectively connected to the power supply 10 via the switch 240 or disconnected from the power supply 10 according to the control unit 40. An emitter of the first transistor Q1 is connected to a first end of the first inductor L1 and the cathode of the third diode D3. A base of the first transistor Q1 is connected to the control unit 40. A second end of the first inductor L1 is grounded via the first capacitor C1, and serves as the output terminal of the buck circuit 242 to output power to the motor 30. The control unit 40 outputs a modulate signal such as a pulse-width modulation (PWM) signal with a changeable duty cycle to adjust how long the first transistor Q1 is on or off.

In one exemplary embodiment, the power supply 10 may be connected to the input terminal of the buck circuit 242. When the PWM signal from the control unit 40 is at a high level, such as a logical “1”, the first transistor Q1 is on. The power supply 10 provides power for the motor 30 via the first inductor L1 and the first capacitor C1, and charges the first inductor L1, the first capacitor C1 such that a voltage of the motor 30 is substantially equal to voltage of the power supply 10. When the PWM signal from the control unit 40 is at a low level, such as a logical “0”, the first transistor Q1 is off. The first inductor L1, the first capacitor C1, and the third diode D3 form a loop circuit. As a result, the voltage of the motor 30 is close to zero. The voltage of the motor 30 varies according to how long the first transistor Q1 is on or off.

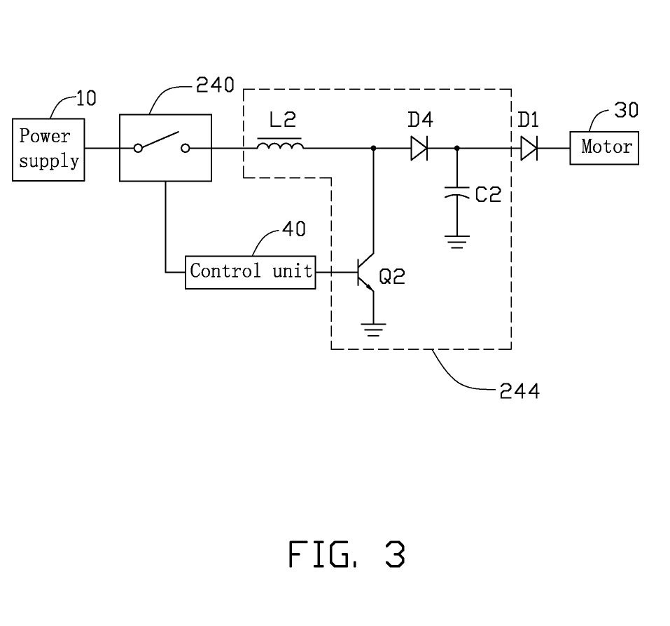

Referring to FIG. 3, the boost circuit 244 includes a second switch such as a second transistor Q2, a second inductor L2, a fourth diode D4, and a second capacitor C2. A first end of the second inductor L2 serves as the input terminal of the boost circuit 244 and is selectively connected to the power supply 10 via the switch 240 or disconnected from the power supply 10 according to the control unit 40. A second end of the second inductor L2 is connected to a collector of the second transistor Q2 and an anode of the fourth diode D4. An emitter of the second transistor Q2 is grounded. A base of the second transistor Q2 is connected to the control unit 40. A cathode of the fourth diode D4 is grounded via the second capacitor C2, and serves as the output terminal of the boost circuit 244 to provide power for the motor 30.

In one exemplary embodiment, the power supply 10 may be connected to the input terminal of the boost circuit 244. When the PWM signal from the control unit 40 is at a high level, such as a logical “1”, the second transistor Q2 is on. The power supply 10 charges the second inductor L2. The second capacitor C2 provides power for the motor 30. When the PWM signal from the control unit 40 is at a low level, such as a logical “0”, the second transistor Q2 is off. The power supply 10 and the second inductor L2 both charge the second capacitor C2, and provide power for the motor 30. As a result, the motor 30 may receive voltage that is higher than the voltage of the power supply 10. In other embodiments, the first and second switches can be other electronic components, such as metal oxide semiconductor field-effect transistors (MOSFETs). The step up circuit can be other circuits, which can step up voltage values, such as a resistor-capacitor (RC) circuit. The step down circuit can be other circuits, which can step down voltage values, such as a circuit with a transformer.

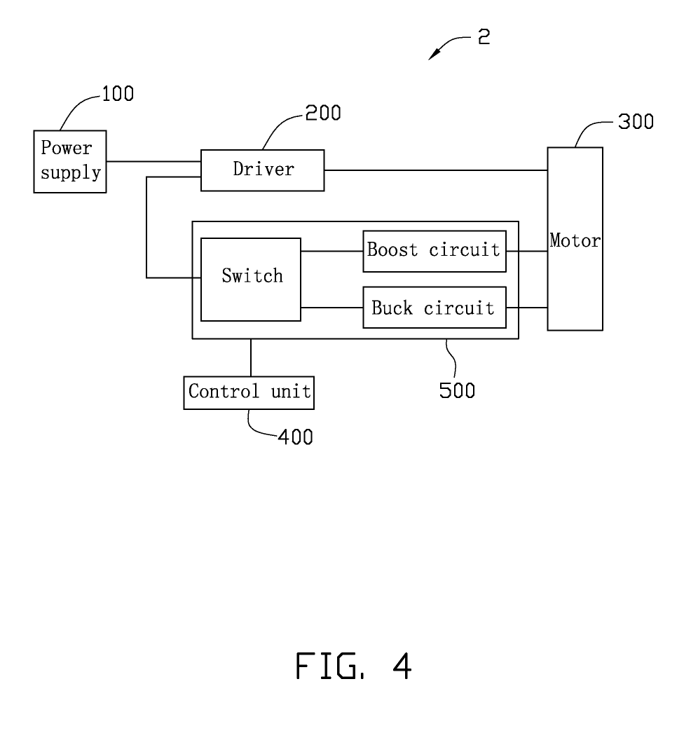

Referring to FIG. 4, a second exemplary motor driving system 2 includes a power supply 100, a driver 200, a motor 300, a control unit 400, and a power converting module 500. The power supply 100 is connected to the driver 200. The driver 200 is also connected to the motor 300 and the power converting module 500. The power converting module 500 is also connected to the motor 300 and the control unit 400. The driver 200 outputs a changeable voltage to the motor 300 via the power converting module 500 according to the control unit 400. The power converting module 500 is similar to the power converting module 24 of the first embodiment of the present disclosure.

The foregoing description of the various inventive embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others of ordinary skill in the art to utilize the disclosure and various embodiments and with various modifications as are suited to the particular use contemplated. Alternately embodiments will become apparent to those of ordinary skill in the art to which the present disclosure pertains without departing from its spirit and scope. Accordingly, the scope of the present disclosure is defined by the appended claims rather than the foregoing description and the various inventive embodiments described therein.

What is claimed is:

1. A motor driving system comprising:
a power supply;
a driver comprising:
a driving module connected to the power supply;
a power converting module connected to the power supply;
a motor comprising a power terminal connected to the power converting module;
a control unit connected to the power converting module;
wherein the power supply is configured to provide power for the driver, the driving module is configured to control the motor, and the control unit is configured to control the power converting module to output a changeable voltage to the motor.

2. The motor driving system of claim 1, wherein the power converting module comprises a first switch, a step up circuit, and a step down circuit, the first switch is connected to the control unit to selectively connect the power supply to an input terminal of the step up circuit or the step down circuit, wherein output terminals of the step up circuit and the step down circuit are connected to the power terminal of the power supply.

3. The motor driving system of claim 2, wherein the power converting module comprises a first diode and a second diode, an anode of the first diode is connected to the input terminal of the step up circuit, a cathode of the first diode is connected to the power terminal of the motor, an anode of the second diode is connected to the input terminal of the step down circuit, a cathode of the second diode is connected to the power terminal of the motor.

4. The motor driving system of claim 2, wherein the step up circuit comprises a second switch, an inductor, and a capacitor, a first terminal of the inductor serving as the input terminal of the step up circuit is selectively connected to the power supply via the first switch or disconnected from the power supply according to the control unit, a second terminal of the inductor is connected to an input terminal of the second switch and an anode of a third diode, an output terminal of the second switch is grounded, a control terminal of the second switch is connected to the control unit to make the second switch be turned on or off in response to a modulate signal from the control unit, a cathode of the third diode is grounded via the capacitor, and serves as the output terminal of the step up circuit to be connected to the power terminal of the motor.

5. The motor driving system of claim 4, wherein the second switch is a transistor, a base of the transistor serves as the control terminal of the second switch, a collector of the transistor serves as the input terminal of the second switch, an emitter of the transistor serves as the output terminal of the second switch.

6. The motor driving system of claim 4, wherein the modulate signal is a pulse-width modulation (PWM) signal.

7. The motor driving system of claim 2, wherein the step down circuit comprises a second switch, an inductor, a capacitor, and a fourth diode, a control terminal of the second switch is connected to the control unit to make the second switch be turned on or off in response to a modulate signal from the control unit, an input terminal of the second switch is selectively connected to the power supply via the first switch or disconnected from the power supply according to the control unit, an output terminal of the second switch is connected to a first terminal of the inductor and a cathode of the fourth diode, an anode of the fourth diode is grounded, a second terminal of the inductor is grounded via the capacitor, and serves as the output terminal of the step down circuit to be connected to the power terminal of the motor.

8. The motor driving system of claim 7, wherein the second switch is a transistor, a base of the transistor serves as the control terminal of the second switch, a collector of the transistor serves as the input terminal of the second switch, an emitter of the transistor serves as the output terminal of the second switch.

9. The motor driving system of claim 7, wherein the modulate signal is a pulse-width modulation (PWM) signal.

10. The motor driving system of claim 2, wherein the step up circuit comprises a transformer, wherein the step down circuit is a resistor-capacitor (RC) circuit.

11. A motor driving system comprising:
a power supply;
a driver connected to the power supply;
a motor comprising a control terminal connected to the driver;
a control unit;
a power converting module connected to the control unit, the driver, and a power terminal of the motor;
wherein the power supply is configured to provide power for the driver, the driver is configured to control the motor, and the control unit is configured to control the power converting module to output a changeable voltage.

12. The motor driving system of claim 11, wherein the power converting module comprises a first switch, a step up circuit, and a step down circuit, the first switch is connected to the control unit to selectively connect the power supply to an input terminal of the step up circuit or the step down circuit, output terminals of the step up circuit and the step down circuit are connected to the power terminal of the power supply.

13. The motor driving system of claim 12, wherein the power converting module comprises a first diode and a second diode, an anode of the first diode is connected to the input terminal of the step up circuit, a cathode of the first diode is connected to the power terminal of the motor, an anode of the second diode is connected to the input terminal of the step down circuit, a cathode of the second diode is connected to the power terminal of the motor.

14. The motor driving system of claim 11, wherein the step up circuit comprises a second switch, an inductor, and a capacitor, a first terminal of the inductor serves as the input terminal of the step up circuit is selectively connect to the power supply via the first switch or disconnected from the power supply according to the control unit, a second terminal of the inductor is connected to an input terminal of the second switch and an anode of a third diode, an output terminal of the second switch is grounded, a control terminal of the second switch is connected to the control unit to make the second switch be turned on or off in response to a modulate signal from the control unit, a cathode of the third diode is grounded via the capacitor, and serves as the output terminal of the step up circuit to be connected to the power terminal of the motor.

15. The motor driving system of claim 12, wherein the second switch is a transistor, the base of the transistor serves as the control terminal of the second switch, the collector of the transistor serves as the input terminal of the second switch, the emitter of the transistor serves as the output terminal of the second switch.

16. The motor driving system of claim 14, wherein the modulate signal is a pulse-width modulation (PWM) signal.

17. The motor driving system of claim 11, wherein the step down circuit comprises a second switch, an inductor, a capacitor, and a fourth diode, a control terminal of the second switch is connected to the control unit to make the second switch be turned on or off in response to a modulate signal from the control unit, an input terminal of the second switch is selectively connected to the power supply via the first switch or disconnected from the power supply according to the control unit, an output terminal of the second switch is connected to a first terminal of the inductor and a cathode of the fourth diode, an anode of the fourth diode is grounded, a second terminal of the inductor is grounded via the capacitor, and serves as the output terminal of the step down circuit to be connected to the power terminal of the motor.

18. The motor driving system of claim 17, wherein the second switch is a transistor, the base of the transistor serves as the control terminal of the second switch, the collector of the transistor serves as the input terminal of the second switch, the emitter of the transistor serves as the output terminal of the second switch.

19. The motor driving system of claim 17, wherein the modulate signal is a pulse-width modulation (PWM) signal.

20. The motor driving system of claim 11, wherein the step up circuit comprises a transformer, the step down circuit is a Resistor-Capacitor (RC) circuit.
